(19) United States
(12) Patent Application Publication
(10) Pub. No.: US 2020/0281391 A1
(43) Pub. Date: Sep. 10, 2020

(54) SOUS-VIDE OVEN MODE WITH PROBE

(71) Applicant: Electrolux Home Products, Inc., Charlotte, NC (US)

(72) Inventors: Steven M. Swayne, Springfield, TN (US); Michael D. Padgett, Springfield, TN (US); Catherine L. May, Springfield, TN (US)

(21) Appl. No.: 16/295,321

(22) Filed: Mar. 7, 2019

(51) Int. Cl. A47J 27/10; A47J 27/18; A23L 5/10; F24C 7/08; A47J 27/21

(52) U.S. Cl. CPC A47J 27/10; A47J 27/18; A47J 27/21058; F24C 7/085; A23L 5/17

(57) ABSTRACT

The present disclosure relates to sous-vide cooking in an oven of a cooking appliance. A temperature probe senses a temperature of a water bath or the food in the water bath, which is placed in the oven cavity. The sensed temperature is used as a feedback input for a controller that controls a heating element of the appliance in a manner that causes the water and food to reach a desired final temperature of the food in equilibrium with the water bath, which in turn is in equilibrium with the air in the cavity.

### BACKGROUND OF THE INVENTION

### 1. Field of the Invention

This application relates generally to sensed cooking and, more specifically, to a temperature probe for sous-vide cooking within an oven cavity of a cooking appliance.

### 2. Description of Related Art

Temperature probes are used in cooking during the preparation of foods. For example, the temperature or humidity/moisture level of meat can be used as an indicator of how well-done or well-cooked the food is. Such measurements can be used in turn to determine a remaining cooking time or to adjust heating parameters.

Separately, “sous-vide” is a technique of cooking food in vacuum sealed containers at low temperatures for longer times than conventional cooking in an oven. Generally, the food is vacuum sealed in a plastic bag (or pouch) and cooked in a water bath (e.g. on a stove-top or in standalone appliance) having its temperature tightly controlled to be about the final desired temperature of the food.

### BRIEF SUMMARY OF THE INVENTION

According to one example described herein, a method for cooking food in a vacuum-sealed package immersed in a water bath located inside an oven cavity comprises: selecting or receiving an input indicating a desired final cooked temperature of the food; detecting a current temperature of the food or of the water bath; operating a heating element to heat air in the oven cavity to maintain said air at or within a predetermined range of a target temperature, the target temperature being equal to or calculated based on the desired final cooked temperature of the food; and maintaining said air at said target temperature or within said range at least until the detected current temperature reaches the desired final temperature plus-or-minus a predetermined offset temperature; the water bath being heated via convection from said air in the oven cavity until said water bath reaches thermal equilibrium with said air, and the food in-turn being heated via conduction from said water bath until said food reaches thermal equilibrium with said water bath.

According to another example described herein, a cooking appliance for cooking food comprises: a user interface configured to receive a user input indicating a desired final cooked temperature of the food; a cavity; a heating element configured to heat air in the cavity via convection; a water bath in the cavity, the food being in a vacuum-sealed package in the water bath; a temperature sensor configured to detect a current temperature of the water bath or a temperature of the food; and a controller operatively connected to the temperature sensor and configured to operate the heating element based on the current temperature detected by the temperature sensor to maintain said air at or within a predetermined range of a target temperature at least until the detected current temperature reaches the desired final temperature plus-or-minus a predetermined offset temperature, the target temperature being equal to or calculated based on the desired final cooked temperature of the food, wherein operation of the heating element by said controller effectuates a temperature change in the water bath via convection from the air in said cavity, and wherein the temperature change in the water bath effectuates a temperature change in the food via conduction from said water bath.

In various embodiments of the above examples, said current temperature is a temperature of the water bath, and the method further comprises or the controller is further configured for maintaining said air at or within said range of said target temperature for a period of time after said detected current temperature reaches the desired final temperature to permit the food to reach said thermal equilibrium with said water bath; said offset temperature is a non-zero offset that is based on unique thermal characteristics of the appliance; the heating element is controlled according to a proportional-integral-derivative (PID) algorithm, and the detected current temperature is a feedback input for the PID algorithm; the temperature of the water bath is detected to yield said current temperature; the temperature of the food is detected to yield said current temperature by piercing the vacuum sealed package with a temperature probe, said offset temperature being zero; the method further comprises circulating water within the water bath or the appliance further comprises a circulator for circulating water within the water bath; the method further comprises displaying the detected temperature or the appliance further comprises a display for displaying the detected temperature; the method further comprises or the controller is further configured for calculating a remaining time until the food achieves the final desired temperature based on the detected temperature, and displaying the remaining time; the target temperature is automatically determined based on a type of the food and a user-selected desired level of doneness of the food, by comparing the type of food and the desired level of doneness to a first lookup table; and/or the type of food is automatically determined based on an impedance characteristic of the food measured by a temperature probe, by comparing the measured impedance characteristic to a second lookup table.

### BRIEF DESCRIPTION OF SEVERAL VIEWS OF THE DRAWING

FIG. 1 shows an example of a cooking appliance in the form of an oven with a front door removed to clearly illustrate an interior of the oven cavity; and

FIG. 2 is a block diagram schematically illustrating communications between a control unit and peripheral components for executing cooking of a food item in the cooking appliance of FIG. 1.

### DETAILED DESCRIPTION OF THE INVENTION

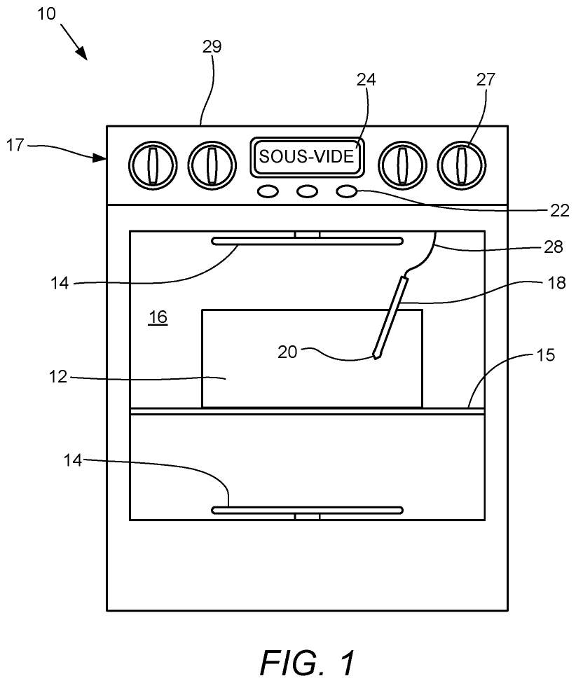

The present disclosure relates to a cooking appliance that facilitates precise sous-vide cooking in an oven cavity, for example, with the aid of a temperature probe. The cooking appliance is shown in FIG. 1 as a general purpose kitchen range 10. This type of appliance is in contrast to other “counter-top” sous-vide cooking devices, such as immersion circulators, that are specifically designed for sous-vide cooking. Using a general purpose appliance such as a kitchen range is convenient for users because such a range (or similar oven) is a common kitchen appliance. Other counter-top devices require special and additional purchases and knowledge to use, and they take up additional space beyond the conventional appliances normally found in the kitchen.

The kitchen range 10 has an oven cavity 16, a cooktop 29, and a display 24, as well as buttons 22, knobs 27, or the like on a user interface 17 for controlling operation of the appliance. Inside the cavity 16 is one or more heating elements 14, such as a resistive heating element or a gas element (e.g., a low flame gas element), and a rack 15. A container 12 for a water bath used in the sous-vide cooking methods described herein rests on the rack 15. For sous-vide cooking, a food item (preferably in a vacuum-sealed package) is submerged and cooked in the water held within the container 12. To facilitate such a cooking method, the heating element(s) 14 in the cavity 16 heats air therein. The air can be circulated via a convection fan (not shown).

After a period of time, the water held by container 12 will equilibrate in temperature with the heated air, so that the water temperature is raised to that of the air temperature in the cavity 16. Tight control of the air temperature will facilitate tight control of the water-bath temperature, which is important for sous-vide cooking. Over time, a food item submerged in the water bath will reach the temperature of the water (and by extension of the air), and accordingly will be cooked to that precise temperature. Sous-vide cooking takes longer than conventional cooking processes because it can take some time for the food item to reach the bath temperature. This is because the bath temperature approximates the desired cooked-food temperature, instead of being set well above that temperature—meaning equilibration will take longer because the temperature gradient between the food and its environment continually is reduced as the food comes to temperature, until ultimately it reaches zero at equilibrium (i.e. when the food is done).

A probe 18 having a parameter-sensitive tip portion 20 can be provided in the container 12 to monitor, for example, a temperature of the water (or other sous-vide cooking medium) therein. When inserted into the water of container 12, the probe 18 senses the water temperature or other parameter in the immediate vicinity of the tip portion 20.

Although not shown, in some embodiments a circulator may be provided to circulate water within the container 12 to help facilitate even thermal distribution throughout the water of the container 12.

In still other embodiments, the probe 18 may be inserted directly into the food item immersed in the water bath in container 12 to monitor the temperature or other parameter of the food directly, during cooking. In these cases, the probe 18 may have a sharper tip portion 20, able to pierce the vacuum-sealed package and the food item.

The sensed temperature or sensed parameter is transduced to an electrical signal and transmitted to a controller of the appliance 10 for further processing. As shown in FIG. 1, this transmission can occur via a wire 28. Such a wire 28 may be permanently attached to the appliance. However, the wire may also be removable with the probe 18 via a plug that interacts with a socket or like interface, for example, in the oven cavity. In still other embodiments, the probe 18 and appliance 10 may each include transceivers for wireless communication of the sensed parameter.

In transducing a sensed parameter, the tip portion 20 of the probe 18 may include one or more thermistors, whose electrical resistance is temperature dependent. In other embodiments, the tip 20 may have a plurality of electrodes used to determine an impedance of the water, which varies with temperature as described in more detail in U.S. Patent Application Publication US 2012/0169354, which is herein incorporated by reference in its entirety. Briefly, based on the measured impedance, a temperature or other feature may be determined. In such a case, a voltage is applied between two electrodes in the tip 20 to generate an electric field within the water from which the electrical impedance of the water may be detected. By detecting the impedance at two different frequencies of electric fields, temperature can be determined by comparing the impedance/frequency relationship to a database of stored relationships. When such a probe is inserted directly into a food item, the type of food may be determined via a similar method because different foods have different impedance characteristics based on their respective compositions, which may be stored in a database.

In still other embodiments, the probe 18 may have a plurality of sensitive tip portions 20, for example, at various positions along a shaft of the probe 18. With such a configuration, temperature at various depths may be determined by the probe 18, from which an average temperature may be determined across that range of depths, a representative temperature may be selected. In other words, the temperature at various locations in the food item may be determined (e.g., at any point between the outside and the center). Any of the measured temperatures may then be considered representative of the temperature of the food item. For example, the measured temperature corresponding to the centermost location of the food item may be considered representative (as this is often the coldest portion of the food), to ensure a proper temperature throughout the food item is achieved. Further, a temperature detection error may be identified, for example, if a temperature difference between two measurement locations is greater than a predetermined threshold. Such a temperature differential may indicate that a portion of the probe is in contact with something other than the food item, for example, a metal element of the container 12 in the oven cavity 16 that may be significantly hotter than the food. If such an error is detected, a user may be prompted to correct placement of the probe 18, or the errant temperature may be disregarded.

In still further embodiments, the probe 18 may be a non-contact temperature sensor that employs a laser or other suitable illumination technique, for example, to monitor a temperature. In this embodiment the probe 18 would be positioned remote from the water bath or food item whose temperature or other parameter is to be detected, and detection thereof will be limited to only its surface, where the laser beam will contact the target.

To operate the cooking appliance 10 in a sous-vide cooking mode, a user may select that mode via the user interface 17, for example, by actuating one of the buttons 22 thereon. The button can be dedicated to activating the sous-vide function. Alternatively, that mode may be activated via a menu-driven selection based on menus displayed on the display 24. In any event, the selected mode may then be identified on the display 24. In conjunction with selecting the cooking mode, a desired cooking temperature also is selected. The temperature may be manually entered by the user via the user interface 17, or automatically selected by the appliance 10, for example from a lookup table, to correspond with a user-identified food and desired level of doneness. For example, if the user identifies a steak is to be cooked to a rare temperature, the desired temperature may be automatically set to 140° F. Alternatively, if the probe 18 is used to identify the food item rather than have the user identify it, then the probe may be inserted into the food item to interrogate the impedance of that item, whereupon the appliance then selects a cooking temperature corresponding to the detected food and the user-selected degree of doneness.

For sous-vide cooking, a user can place the container 12 having the water bath and vacuum-sealed package with the food therein on a rack 15 in the oven cavity 16. In an unmonitored mode, the appliance operates to control a state of the heating elements 14 to heat the oven cavity 16 to the desired temperature, so that the water bath achieves and maintains the desired temperature through equilibration with the surrounding air as described above. Concurrently, as also noted above the food approaches equilibrium with its environment (the water bath and oven cavity 16) at a common temperature equal to the desired cooking temperature. Because the cooking temperature equals the desired endpoint temperature of the food itself, the food item does not overcook, and also will not undercook as long as enough time has elapsed so that the food reaches temperature equilibrium with the surrounding medium (typically water). Accordingly, a limited cooking time is not necessary. Of course, due to natural losses of heat from the appliance (as the oven cavity is not perfectly thermally isolated) and thermal inertia of the oven cavity 16, perfect equilibrium is not necessarily achievable. These losses and the thermal inertia of the oven cavity 16 may be a function of characteristics of individual appliances, for example, the materials used, the size of the oven cavity 16, the amount of insulation around the oven cavity 16, and the like.

To help account for these imperfections in temperature control, the appliance 10 may operate at an offset temperature (e.g., the desired food temperature+/−a predetermined value). In other words, the heating elements 14 may be maintained so as to achieve an oven cavity air temperature equal to the desired food temperature+/−a predetermined value, recognizing that the offset-adjusted cavity air temperature the final water bath and food temperature will be equal to the desired temperature for cooking. As noted above, because thermal loss and inertia are functions of individual appliance characteristics, a unique offset may be determined for each appliance (or model of appliances). The appliance 10 may also be equipped with a convection fan as noted above to facilitate air circulation and even heating within the oven cavity 16.

Control of the heating elements 14 may be performed by a proportional-integral-derivative (PID) controller. The PID controller regulates an element (e.g., a heating element) to deliver an appropriate amount and rate of heat to the oven cavity based on a detected feedback signal (e.g., a temperature of a probe) and comparing that signal to a target temperature of the PID algorithm. As is known in the art, PID control provides less variation and tighter control around a set point temperature than traditional hysteresis control. PID control therefore also provides more consistent and accurate temperatures within the oven cavity 16 during a cooking cycle, and thus helps prevent over- and under-cooking of the food.

The appliance 10 may operate in a monitored sous-vide cooking mode, in which the above-described probe 18 monitors a temperature of the water bath in the container 12, or the food itself. The detected temperature by the probe can then represent a feedback signal used to control the heating elements, for example, with the PID controller. The detected temperature may also be used to calculate or estimate a remaining time until the temperature of the food reaches the desired final cooked temperature, which can be displayed or updated on display 24 in real-time for the user's information.

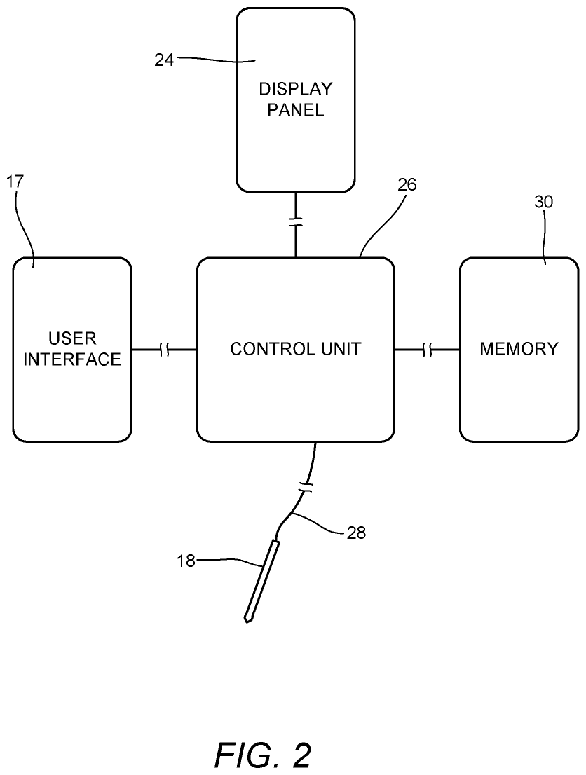

More specifically with reference to FIG. 2, the monitored sous-vide cooking mode described herein controls heating of the oven cavity 16 in response to a signal transmitted from the probe 18 to a controller 26. In other words, the temperature of the water or food is used as a feedback signal for controlling the heating elements 14, rather than the temperature of the oven cavity 16 as in an unmonitored cooking mode. In so doing, the appliance 10 more accurately heats the water (and thus the food) inside the container 12 to the desired temperature because temperature measurement of the bath (or food) is direct, as opposed to indirect via the intervening medium of air. To achieve this operation, the probe 18 is operatively coupled to a controller 26 of the appliance 10 and placed in the cooking medium (or food) to automatically and without human intervention transmit a temperature signal to controller 26. As noted above, this connection between the probe 18 and the controller 26 can be facilitated by hardwire with a wire 28 or wireless communication while the probe 18 is at least partially inserted into the water bath. The controller 26 can then determine the temperature of the water bath inside the container 12. For instance, based on the temperature signal from the probe 18, the controller 26 can determine that the water temperature has reached a level corresponding to the desired temperature of the food, is less than the desired temperature, or is greater than the desired temperature. With this feedback information, a state or duty cycle of the heating element 14 (e.g., on, off, power level, duty cycle) is adjusted by controller 26 in a manner that causes the water to be maintained at the desire temperature.

As noted above, ideally the temperature of the water corresponds to the temperature of the food; however, actual conditions may not be ideal. Therefore, when the temperature of the water is measured by probe 18, and offset may again be used to account for any thermal losses between the water and the food. For example, it may be determined in a particular oven that the food temperature is often one degree less than the water temperature; thus, when the temperature of the water is measured by the probe 18, the food temperature can be estimated as the water temperature minus a one degree offset, so that to achieve the desired cooking temperature in the food a one-degree positive offset is entered into the controller so that the water temperature is elevated by one degree compared to the setpoint.

The controller 26 can include electronic hardware (e.g. circuitry, integrated circuits, and the like) for controlling operation of one or more of the heating elements 14. In other words, the controller 26 may use the temperature signal from the probe 18 as an input to an algorithm (e.g., a PID or hysteresis algorithm) used to control the heating elements 14 within the cavity. The controller 26 may also be used to similarly control operation of other features of the appliance 10, for example a convection fan. Operation of any such feature may be adjusted to control for the above-noted natural imperfections (e.g., thermal inertia and losses).

Physically, control of the heating elements 14 controls the oven cavity 16 temperature, and thus the water within the container 12, via convection. The food, however, being submerged with the water of container 12, is heated via conduction. Because energy transfer via conduction is more efficient, cooking the food within the water of container 12 may provide faster cooking (e.g., 25% faster until equilibrium is reached), than simply placing the food directly on a rack 15 to be cooked by convection, provided that the water bath already is up to temperature when the food is inserted. Further, because the food is cooked via conduction submerged within the water, the high thermal mass of water compared to the surrounding air means that the temperature experienced by the food itself will be less susceptible to discrete fluctuations in air temperature, for example from opening and closing the oven door. That is, the water bath itself acts as a thermal buffer between the air (which is subject to large temperature fluctuations) and the food, thus ensuring more consistent cooking and temperature maintenance despite such fluctuations. As a result, heating elements 14 may be used to heat the oven cavity by the controller 26 with more flexibility than in conventional air-cooking modes.

For example, some cooking modes require consideration of the location of the heating element 14 within the cavity (e.g. bake vs. broil) because the area immediately around the heating element will be hotter than those areas farther away. But in sous-vide cooking this consideration is largely irrelevant because the water bath will be generally uniform in temperature such that the food item will experience the same cooking temperature from all directions.

The controller can also be used to provide an audible and/or visual indication of cooking status to the user interface 17. For example, the display 24 of the user interface 17 may display a current water temperature so that the user may monitor the current cooking status. Upon reaching the desired temperature, a buzzer may sound to alert the user of the status. In other embodiments, the controller may monitor the rate at which water temperature has changed and/or how long the water temperature has been at a certain level. With this information, the controller may estimate a time at which the food will reach the desired temperature based on other parameters, such as the food's mass and characteristics, which may be user-specified or detected by the appliance. This may be determined by an algorithm, or a predetermined lookup table or database that relates cook times at different temperatures to different types and amounts of foods. This remaining time may be updated in real-time or periodically throughout cooking and displayed on the display 24. At the completion of the remaining time, the display may be updated to show and/or a buzzer may sound to alert the user that the food is finished cooking.

According to some embodiments, the controller 26 can include a microprocessor that is operable to execute computer-executable instructions stored in a computer-readable memory of the appliance 10 to perform any, all or any combination of the functions described herein. The computer-readable memory 30 shown in FIG. 2 is operatively coupled in communication with the controller 26 and stores the computer-executable instructions to be executed in response to receiving the signal from the probe 18 to initiate any, all or any combination of the functions described herein. According to alternate embodiments, the computer-executable instructions can optionally be stored in a non-volatile computer-readable memory embedded within the microprocessor itself. The computer-readable memory 30 can also store a database of minimum target internal temperatures for specific food items, and/or target internal temperatures for various degrees of cooking or “doneness” for specific food items, relationships between detected parameters and specific types of food items, relationships between detected parameters and temperature, and other information helpful for executing the functions described herein.

It is noted that the probe 18 is not unique to water or to the above-described sous-vide mode. Rather, the probe 18 may be used in a similar fashion with respect to other cooking modes. For example, a user may initiate a monitored turkey mode of the appliance. In this case, the user inserts a turkey into the oven cavity 16 and inserts the probe 18 into the turkey. As above, the user may further indicate a cooking time and a desired temperature. Alternatively, one or both of these parameters may be automatically selected by the appliance 10, for example, with reference to a database stored in memory. This type of monitored control is explained in more detail in U.S. Patent Application Publication 2010/006558, which is herein incorporated by reference in its entirety.

Certain terminology has been used herein for convenience only and is not to be taken as a limitation on the present invention. Relative language is best understood with reference to the drawings, in which like numerals are used to identify like or similar items. Further, in the drawings, certain features may be shown in somewhat schematic form.

Still further, although the above described embodiments are preferred embodiments, it should also be understood that modifications can be made thereto without departing from the spirit and the scope of the invention as set forth in the appended claims. Accordingly, it should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A method for cooking food in a vacuum-sealed package immersed in a water bath located inside an oven cavity, the method comprising:
selecting or receiving an input indicating a desired final cooked temperature of the food;
detecting a current temperature of the food or of the water bath;
operating a heating element to heat air in the oven cavity to maintain said air at or within a predetermined range of a target temperature, the target temperature being equal to or calculated based on the desired final cooked temperature of the food; and
maintaining said air at said target temperature or within said range at least until the detected current temperature reaches the desired final temperature plus-or-minus a predetermined offset temperature;
the water bath being heated via convection from said air in the oven cavity until said water bath reaches thermal equilibrium with said air, and
the food in-turn being heated via conduction from said water bath until said food reaches thermal equilibrium with said water bath.

2. The method of claim 1, said current temperature being a temperature of the water bath, the method further comprising maintaining said air at or within said range of said target temperature for a period of time after said detected current temperature reaches the desired final temperature to permit the food to reach said thermal equilibrium with said water bath.

3. The method of claim 1, said offset temperature being a non-zero offset that is based on unique thermal characteristics of the appliance.

4. The method of claim 1, the heating element being controlled according to a proportional-integral-derivative (PID) algorithm, and the detected current temperature being a feedback input for the PID algorithm.

5. The method of claim 1, wherein the temperature of the water bath is detected to yield said current temperature.

6. The method of claim 1, wherein the temperature of the food is detected to yield said current temperature by piercing the vacuum sealed package with a temperature probe, said offset temperature being zero.

7. The method of claim 1, further comprising circulating water within the water bath.

8. The method of claim 1, further comprising displaying the detected temperature.

9. The method of claim 1, further comprising calculating a remaining time until the food achieves the final desired temperature based on the detected temperature; and displaying the remaining time.

10. The method of claim 1, wherein the target temperature is automatically determined based on a type of the food and a user-selected desired level of doneness of the food, by comparing the type of food and the desired level of doneness to a first lookup table.

11. The method of claim 10, wherein the type of food is automatically determined based on an impedance characteristic of the food measured by a temperature probe, by comparing the measured impedance characteristic to a second lookup table.

12. A cooking appliance for cooking food, comprising:
a user interface configured to receive a user input indicating a desired final cooked temperature of the food;
a cavity;
a heating element configured to heat air in the cavity via convection;
a water bath in the cavity, the food being in a vacuum-sealed package in the water bath;
a temperature sensor configured to detect a current temperature of the water bath or a temperature of the food; and
a controller operatively connected to the temperature sensor and configured to operate the heating element based on the current temperature detected by the temperature sensor to maintain said air at or within a predetermined range of a target temperature at least until the detected current temperature reaches the desired final temperature plus-or-minus a predetermined offset temperature, the target temperature being equal to or calculated based on the desired final cooked temperature of the food,
wherein operation of the heating element by said controller effectuates a temperature change in the water bath via convection from the air in said cavity, and
wherein the temperature change in the water bath effectuates a temperature change in the food via conduction from said water bath.

13. The cooking appliance of claim 12, said current temperature being a temperature of the water bath, the controller being further configured to maintain said air at or within said range of said target temperature for a period of time after said detected current temperature reaches the desired final temperature to permit the food to reach said thermal equilibrium with said water bath.

14. The cooking appliance of claim 12, said offset temperature being a non-zero offset that is based on unique thermal characteristics of the appliance.

15. The cooking appliance of claim 12, the controller being configured to control the heating element according to a proportional-integral-derivative (PID) algorithm, wherein the detected temperature is provided to the controller as a feedback input for the PID algorithm.

16. The cooking appliance of claim 12, said current temperature being of the water bath.

17. The cooking appliance of claim 12, the temperature sensor being configured to detect the current temperature of the food by piercing the vacuum sealed package and being inserted into the food, said offset temperature being zero.

18. The cooking appliance of claim 12, further comprising a circulator configured to circulate water within the water bath.

19. The cooking appliance of claim 12, further comprising a display configured to display the detected current temperature.

20. The cooking appliance of claim 12, the controller being further configured to calculate a remaining time until the food achieves the final desired temperature based on the detected current temperature, the cooking appliance further comprising a display configured to display the remaining time.

21. The cooking appliance of claim 12, the controller being further configured to determine the target temperature based on a type of the food and a user-selected desired level of doneness of the food by comparing the type of food and the desired level of doneness to a first lookup table.

22. The cooking appliance of claim 21, the controller being further configured to determine the type of food based on an impedance characteristic of the food measured by a temperature probe, by comparing the measured impedance characteristic to a second lookup table.
